(19) United States
(12) Patent Application Publication
(10) Pub. No.: US 2017/0069005 A1
(43) Pub. Date: Mar. 9, 2017

(54) SYSTEMS AND METHODS FOR CREATING AN AUTOMATED USER QUOTATION INTERFACE WITH DYNAMIC SYSTEM RESPONSE

(71) Applicant: HBP, Inc., Hagerstown, MD (US)

(72) Inventor: David M. KIRKMAN, Hagerstown, MD (US)

(21) Appl. No.: 15/248,956

(22) Filed: Aug. 26, 2016

Related U.S. Application Data
(60) Provisional application No. 62/214,688, filed on Sep. 4, 2015.
(60) Provisional application No. 62/214,664, filed on Sep. 4, 2015.
(60) Provisional application No. 62/214,649, filed on Sep. 4, 2015.

(51) Int. Cl. G06Q 30/06

(52) U.S. Cl. CPC G06Q 30/0611; G06Q 30/0641; G06Q 30/0625

(57) ABSTRACT

Systems and methods for creating a an automated quotation with dynamic system response re disclosed. A method may include (1) receiving identification information from a user; (2) routing the user through a portal to a user interface; (3) transmitting the identification information through the portal to the user interface; (4) receiving a selection of a product offering at the user interface; (5) dynamically creating a follow-up product specification query dependent on the received user product selection; (6) receiving a response to the product specification query; (7) dynamically creating additional follow-up product specification queries until the product selected by the user is fully specified; (8) transmitting the user product selection and follow-up product specification query responses to a quotation generator; (9) routing the user through the portal to the quotation generator; and (10) creating a job quotation based on the user product selection and follow-up product specification query responses.

### RELATED APPLICATIONS

The present application claims priority to U.S. Provisional Patent Application Ser. No. 62/214,688; 62/214,664; and 62/214,649. The disclosures of each of these documents is hereby incorporated, by reference, in its entirety.

### BACKGROUND OF THE INVENTION

1. Field of the Invention

The present disclosure generally relates to systems and methods for creating a user quotation interface with dynamic system response.

2. Description of the Related Art

Providing estimates for custom projects, such as printing projects, is a complex and time consuming effort. The myriad of options available to the project requester can result in confusion, leading to incomplete requests or mistakes.

### SUMMARY OF THE INVENTION

Embodiments disclosed herein generally relate to creating automated user quotations with dynamic system response. For example, in one embodiment a method may include (1) receiving identification information from a user; (2) routing the user through a portal to a user interface; (3) transmitting the identification information through the portal to the user interface; (4) receiving, from the user, a selection of a product offering at the user interface; (5) dynamically creating, by at least one computer processor associated with the user interface, a follow-up product specification query dependent on the received user product selection; (6) receiving, from the user, a response to the product specification query; (7) dynamically creating, by the at least one computer processor, additional follow-up product specification queries based on received user responses, until the product selected by the user is fully specified; (8) transmitting the user product selection and follow-up product specification query responses to a quotation generator; (9) routing the user through the portal to the quotation generator; and (10) creating, with the at least one computer processor, a job quotation based on the user product selection and follow-up product specification query responses.

In one embodiment, the method may also include (1) comparing the user identification information against a database of past user identification information, user product selections, and follow-up product specification query responses; and (2) transmitting, upon matching user identification with past user identification information, past user product selections, and follow-up product specification query responses with the identification information, through the portal to the user interface.

In one embodiment, the a computer processor may utilize past user product selections and input to dynamically customize the follow-up product specification queries.

In one embodiment, the method may also include storing, in computer memory, the user identification information, user product selection, and follow-up product specification query responses.

In one embodiment, the job quotation may be stored in computer memory for a limited duration.

In one embodiment, the user interface may be a website.

In one embodiment, the method may also include (1) displaying the job quotation to the user; (2) receiving user approval of the job quotation; (3) transmitting the job quotation to an order module; (4) providing payment means to the user; and (5) receiving user payment for the quoted job.

In one embodiment, the method may also include (1) transmitting the job quotation and a user payment confirmation to a production module; (2) scheduling manufacturing of the quoted job; and (3) manufacturing the quoted job.

In one embodiment a method may include (1) providing a user interface to enable entry of user information; (2) receiving identification information from a user; (3) receiving, from the user, a selection of a product offering; (4) dynamically creating, by at least one computer processor associated with the user interface, a follow-up product specification query dependent on the received user product selection; (5) receiving, from the user, a response to the product specification query; (6) dynamically creating, by the at least one computer processor, additional follow-up product specification queries based on received user responses, until the product selected by the user is fully specified; and (7) creating, with the at least one computer processor, a job quotation based on the user product selection and follow-up product specification query responses.

In one embodiment, the method may also include (1) comparing the user identification information is compared against a database of past user identification information, user product selections, and follow-up product specification query responses; (2) matching user identification with past user identification information, past user product selections, and follow-up product specification query responses with the identification information; and (3) utilizing, by the at least one computer processor, the past user product selections, and follow-up product specification query responses to dynamically customize the follow-up product specification queries.

In one embodiment, the method may also include (1) displaying the job quotation to the user; (2) receiving user approval of the job quotation (3) transmitting the job quotation to an order module; (4) providing payment means to the user; and (5) receiving user payment for the quoted job.

In one embodiment, the method may also include (1) transmitting the job quotation and a user payment confirmation to a production module; (2) scheduling manufacturing of the quoted job; and (3) manufacturing the quoted job.

In one embodiment a system may include (1) an electronic device configured to run a product quotation software application; (2) a network configured to couple the electronic device with a server; (3) the server configured to host an application software module; (4) an application software module comprising a quotation portal and a quotation generator; (5) the quotation portal configured to transmit both user information, and users, to a user interface; (6) the quotation generator configured to provide product quotations; and (7) a user interface configured to receive user product specification input and dynamically create product specification queries based on received user product specification input.

In one embodiment, the system may be configured to host a user information database configured to store user identification information and user product specification input.

In one embodiment, the application software module may be further configured to compare user identification information against a list of past user identification data stored in the user information database

In one embodiment, the user interface may be further configured to utilize past user product specification input to dynamically customize product specification queries.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for a user quotation interface featuring dynamic system responses according to one embodiment;

FIG. 2 depicts an application software module and a quotation portal back end module according to one embodiment; and

FIG. 3 depicts a method for providing a user quotation interface featuring dynamic system responses according to one embodiment.

### DETAILED DESCRIPTION OF PREFERRED EMBODIMENTS

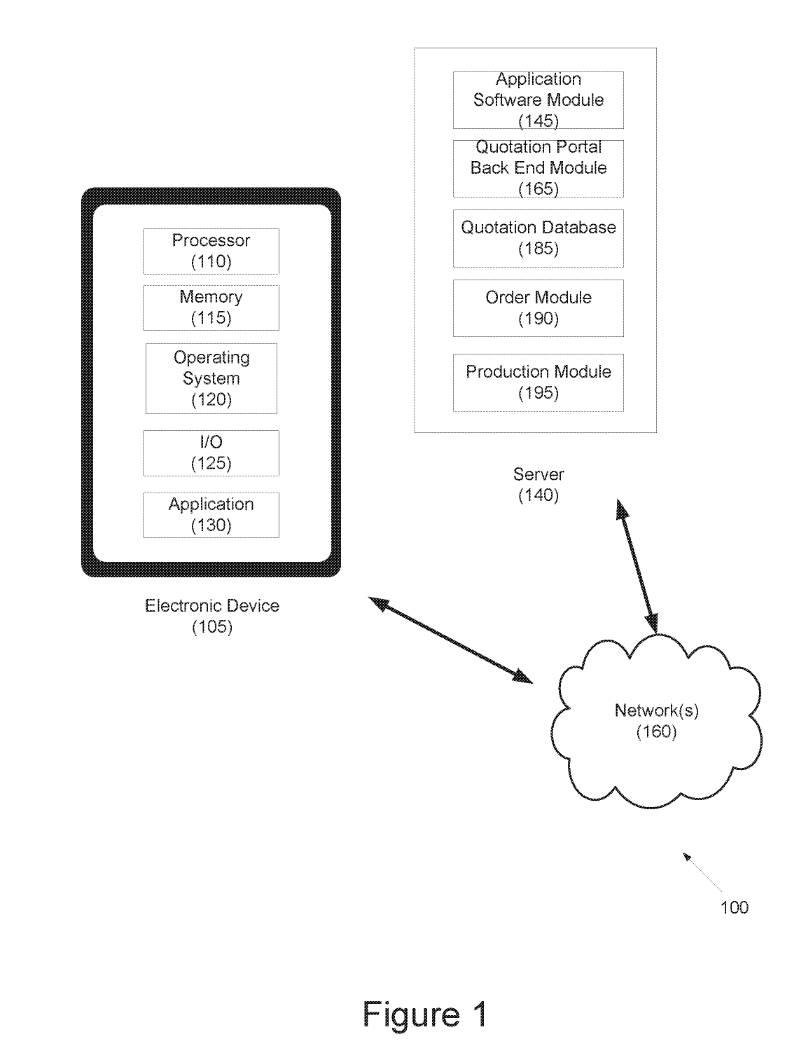

Several embodiments of the present invention and their advantages may be understood by referring to FIGS. 1-3.

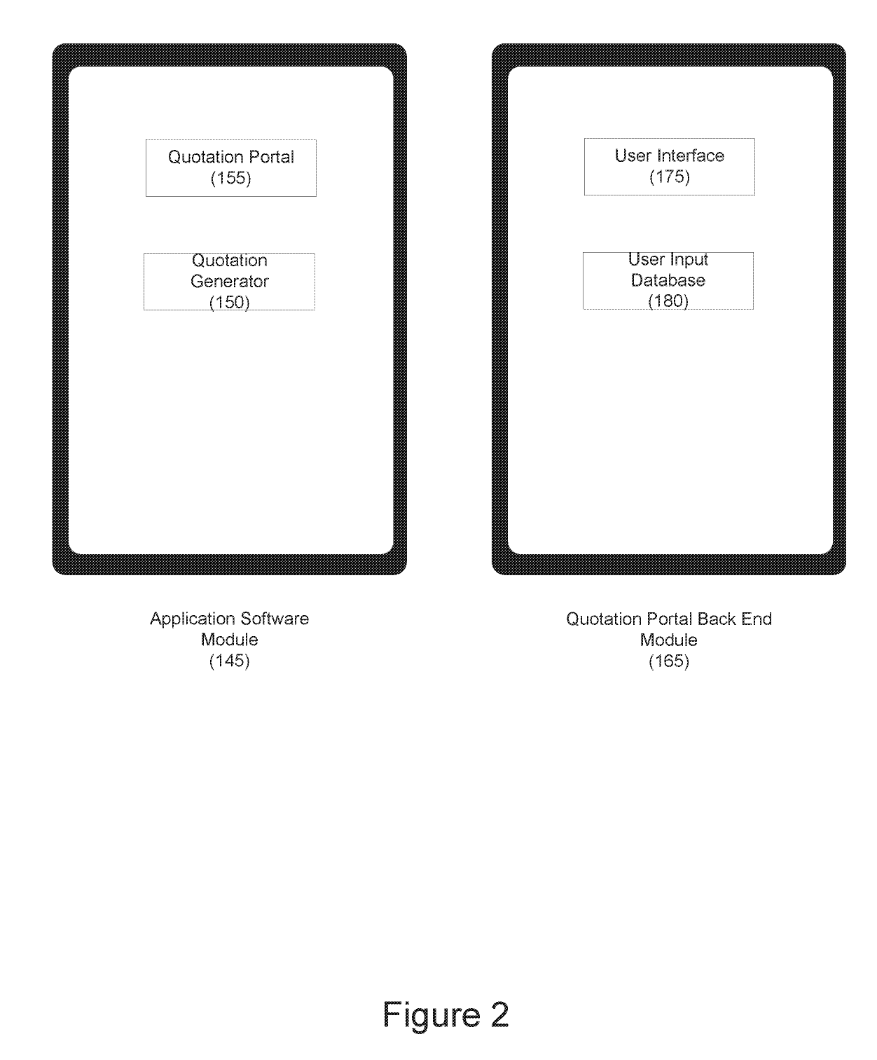

Referring to FIGS. 1 and 2, a block diagram of a system for a user quotation interface featuring dynamic system responses is disclosed according to one embodiment. System 100 may include electronic device 105, one or more network(s) 130, and server 140. Electronic device 105 may include any suitable device, including smartphones, tablet computers, notebook computers, netbook computers, e-reading devices, desktop computers, workstations, etc. Examples include Apple's iPhone and iPad, Samsung's Galaxy, etc.

In one embodiment, electronic device 105 may include one or more processor 110, memory 115, and an operating system 120 executed by processor 110. Electronic device may further include input/output (“I/O”) 125 which may include wireless communication capability, touch/keypad inputs, voice input, etc.

One or more computer program or application 130 may be stored in memory 115 and may be executed by processor 110. In one embodiment, application 130 may include software capable of providing a user quotation interface featuring dynamic system responses.

Electronic device 105 may communicate with an external site (e.g., a website) capable of providing a user quotation interface featuring dynamic system responses, using network(s) 135. One or more external network(s) 135 may be provided, and may comprise any suitable communication network or combination of communication networks, including wired, WiFi, cellular, Bluetooth, NFC, etc.

Server 140 may include one or more computer processors (not shown), application software module 145, quotation portal back end module 165, quotation database 185, order module 190, and production module 195.

In one embodiment, electronic device 105 and server 140 may be the same device.

Application software module 145 may comprise quotation generator 150 and quotation portal 155.

Quotation generator 150 may be configured to receive user identification information, for example, name, business name, address, account ID, password, etc. Quotation generator 150 may be configured to send and receive data from, for example, quotation database 185, quotation portal 155, etc. For example, quotation generator 150 may be configured to send user identification information to quotation database 185, or to send user identification information and prior user quotation information to quotation portal back end module 165 through quotation portal 155. The user information may be shared encrypted, unencrypted, or translated into a propriety identification string, barcode, or the like.

Quotation generator 150 may utilize user data to create job quotations, and may be further configured to output a job quotation to order module 190 and production query module 195.

Quotation portal 155 may be configured to interface with quotation portal back end module 165. Quotation portal 155 may send and receive data from quotation portal back end module 165. In one embodiment, quotation portal 155 may also provide users access to quotation portal back end module 165.

Quotation portal back end module 165 may include a user interface 175, and a user input database 180.

User interface 175 may be configured to allow communication between application software module 145 and quotation portal back end module 165. For example, user interface 175 may send and receive data from the quotation portal 155.

User interface 175 may be further configured to provide a graphical user interface to users. In one embodiment, the graphical user interface may present a series of queries regarding products and product features.

User interface 175 may be configured to receive input from a user, and the user input may be in the form of product and product feature selections. User interface 175 may use the user input to dynamically create or select follow up queries regarding product features.

User input database 180 may be configured to receive, store, and transmit data input by users in user interface 175.

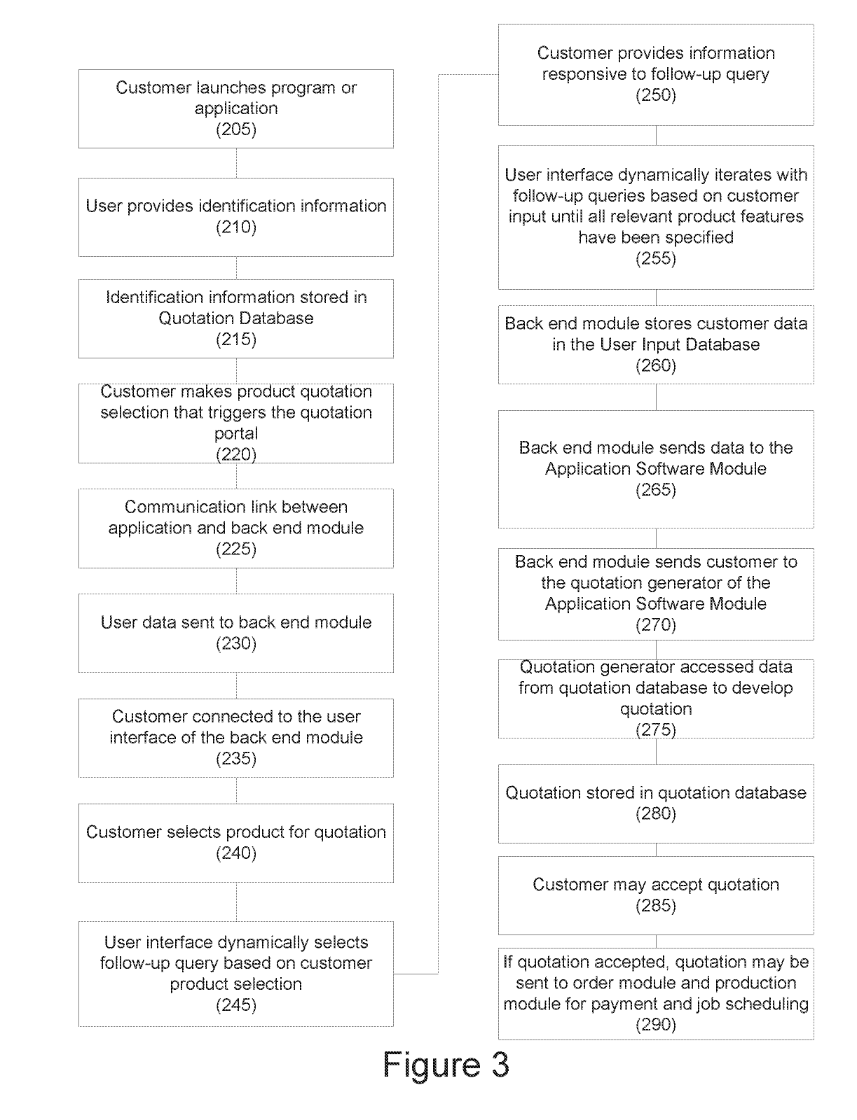

Referring to FIG. 3, a method for creating, distributing, and granting access to protected content is described according to one embodiment.

In step 205, a user may launch or execute a computer program, application, etc. such as a product quotation application, on an electronic device.

In step 210, the user may provide identification information at a quotation generator of an application software module. The identification information may include information that helps identify the user, such as name, company name, address, user ID, account ID, account password, etc.

In step 215, the identification information may be stored in any suitable database, such as a quotation database.

In one embodiment, a quotation generator may attempt to identify the user by comparing the user identification information against identification data stored in the quotation database. If the quotation generator matches identification information to existing identification data, the quotation generator may link past quotation data such as preferences, previous product selections, and the like with the user identification information.

In step 220, the user may make a product selection using the quotation generator that requires further specification of product features prior to quotation.

In step 225, a quotation portal may initiate a communication link with a user interface of a quotation portal back end module.

In step 230, the quotation generator may access the user's identification information, and any associated quotation data, on the quotation database and return it via the quotation portal to the user interface of the quotation portal back end module. The user interface may also store the user data in the user input database. The user data may be formatted by the application software module prior to sending through the quotation portal. Formatting may consist of encryption, creation of a proprietary identification protocol, 2-D or 3-D barcode, or any other form of secure or unsecure unique user identification.

In step 235, the user may be routed from the quotation generator, through the quotation portal to the user interface of the quotation portal back end module.

In step 240, the user interface may present a list of available product offerings. The list of available product offerings may be presented graphically, by text, etc. For example, the product list may include envelops, books, pocket folders, business cards, etc. The list of potential products may also include an option for “other” or “everything else.”

If the user was identified at step 215, the user interface may analyze the past user quotation data so that it may display or highlight previous selections or preferences, or de-emphasize selections for which the user has shown no preference.

At this step, the user may select a desired product for quotation within the user interface. The user selection may be made in any suitable manner, including by clicking on a graphical representation of the product, clicking on the name of the product, selecting a product from a drop-down menu, typing the name of the desired product, etc.

At step 245, the user interface may process the user selection and dynamically create a follow-up query based on the user selection.

For example, if a user selects business cards, then user interface may use that selection to dynamically create a follow-up query for the type of card stock, which may, for example, include foil, emboss, UV coated, or the like.

In one embodiment, the user interface may use past user quotation data to streamline the user feature selection process. For example, user interface may pre-select, de-select, highlight, de-emphasize, etc. one or more possible selections from the follow-up query, based on previous user selections, perceived user preferences, or other patterns discerned from the past user quotation data.

For example, if the past user quotation data indicates that the user orders business cards and envelops in a regular alternating manner, user interface may infer the product and features based on this pattern, and pre-populate, or otherwise customize, the user interface. As another example, if the past user quotation data indicates that the user orders business cards in July each year, and the user is accessing the application in July, the user interface may infer the product and/or product features.

In one embodiment, the system may dynamically present follow-up queries based on, for example, anticipated timing, raw material availability, resource availability, pricing, etc. For example, if the user is requesting a quick turn-around time, and certain raw materials (e.g., a specific type of paper) would not be available within that timeframe, the user may not be presented with the option for that paper.

At step 250, a user may provide input responsive to the follow-up query created by user interface. The user input may be made in any suitable manner, including by clicking on a graphical representation of a specific product feature or a characteristic of a product feature, clicking a textual description of the product feature or characteristic of a product feature, selecting the same from a drop-down menu, etc.

At step 255, similar to step 245, the user interface may process the user information input at step 250, and dynamically create a follow-up query based on the user input.

For example, if a user selects business cards, the user interface may dynamically provide a follow-up query regarding the type of card stock. User input to that query may prompt another query from the user interface. For example, the user interface may query a user as to finishing features available for the selected card stock, such as UV coating, foil, emboss, rounded corners, etc. Or, if the user interface queries as to the use of colors, based on user input, the user interface may provide a follow-up query as to specific colors and placement of those colors.

Steps 255 and 250 may be iterated until all features and specifications for a selected product have been defined. For example, if a user selects envelopes as the product at step 240, the user interface may query as to the envelope size. The user interface may then query as to the paper stock for the envelops, and then the colors, location for colors (front/back/inside), security tint, window, window placement, etc. Once all features have been specified, the user interface may discontinue further queries.

At one or more point in the iterative process, the user interface may use past user quotation data to create a user-customized interface, or to otherwise streamline the iterative process. For example, a user may select business cards as the product, and the user interface may follow-up with a query regarding the card finishing type. The user may select a finishing type, and the user interface may then follow-up with a query regarding card finishing including thermography, litho, and/or the number of colors. Based on user input, the user interface may then query regarding specific colors, number of sides, varnish, etc. The user interface may then query regarding names, designs, placement, etc. However, if past user quotation data indicates a history of purchasing a certain business card design, the user interface may pre-populate or highlight those fields, de-emphasize the other fields, pre-select the fields or otherwise skip queries that match a prior selected design, and seek user approval of a prior business card layout. The user interface may also begin the iterative process but then skip to a finalized card design if user input is tracking past choices that indicate the user will select a prior business card layout.

In step 260, the quotation portal back end module may store the user input data in the user input database.

In step 265, the quotation portal back end module may communicate the user input data, coupled with the user identification information, to the quotation database. The information may be encrypted, unencrypted, part of a proprietary identification scheme, or any other method of formatting the data for transfer as is necessary and/or desired.

In step 270, the quotation portal back end module may direct the user back through the quotation portal to quotation generator.

In step 275, the quotation generator may access the user input data stored in quotation database. The quotation generator may utilize this data to generate a job quotation for the user.

For example, the quotation generator may utilize the user input data to determine material and processing costs. The quotation generator may also apply a margin or discount based on any number of factors including standard discount, volume-based discount, manufacturing capacity, customer loyalty, account retention, negotiated rate discount, etc.

In one embodiment, the current or anticipated production workload and/or machine utilization may be retrieved. For example, if the current or anticipated workload is high, the quotation may be adjusted appropriately to reflect demand.

In another embodiment, the importance of the user may be dynamically determined. If the user is expected to provide additional projects in the future, the quotation may be adjusted appropriately. Similarly, if it can be determined that the user is a customer of a competitor, the quotation may be adjusted downward.

In still another embodiment, competitor pricing may be considered in determining the quotation, to the extent available. For example, in one embodiment, the quotation generator may identify competitor's pricing from, for example, competitors' websites, social medial, etc. It may further identify additional information about the customer and/or the customer's company, if unknown. The quotation generator may then use that information to dynamically adjust the job quotation.

Other factors that may be considered include the profitability of the sales class, the profitability of the customer, the customer tier (e.g., prospect, new, experienced, strategic partner, etc.), the job value tier, historical pricing for the job with the customer (e.g., repeat job), etc. Any one or more of these considerations may be applied in generating the quotation for the job.

In one embodiment, the quotation generator may provide the job quotation to the user.

At step 280, the job quotation may be stored in the quotation database. The job quotation may be linked to and stored with the user identification data and any past user quotation data. The job quotation may be stored permanently or deleted after some trigger event such as a threshold time, user rejection of the job quote, etc.

At step 285, the user may accept the job quotation.

At step 290, if the user has accepted the job quotation, the quotation generator may communicate the job quotation to an order module for payment processing and the production module for job scheduling.

In one embodiment, the job may be routed to the production equipment (e.g., printer, etc.) that can provide the requested features. In another embodiment, raw materials, if not available, may be automatically ordered and requested to be shipped to the identified production equipment.

In one embodiment, if provided electronically, the underlying job (e.g., text/graphics/etc. to print) may be communicated to the production equipment for production.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for creating an automated quotation with dynamic system response, comprising:
receiving identification information from a user;
routing the user through a portal to a user interface;
transmitting the identification information through the portal to the user interface;
receiving, from the user, a selection of a product offering at the user interface;
dynamically creating, by at least one computer processor associated with the user interface, a follow-up product specification query dependent on the received user product selection;
receiving, from the user, a response to the product specification query;
dynamically creating, by the at least one computer processor, additional follow-up product specification queries based on received user responses, until the product selected by the user is fully specified;
transmitting the user product selection and follow-up product specification query responses to a quotation generator;
routing the user through the portal to the quotation generator;
creating, with the at least one computer processor, a job quotation based on the user product selection and follow-up product specification query responses.

2. The method of claim 1 further comprising;
comparing the user identification information against a database of past user identification information, user product selections, and follow-up product specification query responses; and
transmitting, upon matching user identification with past user identification information, past user product selections, and follow-up product specification query responses with the identification information, through the portal to the user interface.

3. The method of claim 2, wherein the at least one computer processor utilizes the past user product selections and input to dynamically customize the follow-up product specification queries.

4. The method of claim 3 further comprising;
storing, in a computer memory, the user identification information, user product selection, and follow-up product specification query responses.

5. The method of claim 4, wherein the job quotation is stored in the computer memory for a limited duration.

6. The method of claim 1, wherein the user interface is a website.

7. The method of claim 1 further comprising;
displaying the job quotation to the user;
receiving user approval of the job quotation;
transmitting the job quotation to an order module;
providing payment means to the user; and
receiving user payment for the quoted job.

8. The method of claim 7 further comprising;
transmitting the job quotation and a user payment confirmation to a production module;
scheduling manufacturing of the quoted job; and
manufacturing the quoted job.

9. A method for creating an automated quotation with dynamic system response, comprising:
providing a user interface to enable entry of user information;
receiving identification information from a user;
receiving, from the user, a selection of a product offering;
dynamically creating, by at least one computer processor associated with the user interface, a follow-up product specification query dependent on the received user product selection;
receiving, from the user, a response to the product specification query;
dynamically creating, by the at least one computer processor, additional follow-up product specification queries based on received user responses, until the product selected by the user is fully specified; and
creating, with the at least one computer processor, a job quotation based on the user product selection and follow-up product specification query responses.

10. The method of claim 9 further comprising;
comparing the user identification information is compared against a database of past user identification information, user product selections, and follow-up product specification query responses;
matching user identification with past user identification information, past user product selections, and follow-up product specification query responses with the identification information; and
utilizing, by the at least one computer processor, the past user product selections, and follow-up product specification query responses to dynamically customize the follow-up product specification queries.

11. The method of claim 9 further comprising;
displaying the job quotation to the user;
receiving user approval of the job quotation;
transmitting the job quotation to an order module;
providing payment means to the user; and
receiving user payment for the quoted job.

12. The method of claim 11 further comprising;
transmitting the job quotation and a user payment confirmation to a production module;
scheduling manufacturing of the quoted job; and
manufacturing the quoted job.

13. A system for creating an automated quotation with dynamic system response, comprising:
an electronic device configured to run a product quotation software application;
a network configured to couple the electronic device with a server;
the server configured to host an application software module;
an application software module comprising a quotation portal and a quotation generator;
the quotation portal configured to transmit both user information, and users, to a user interface;
the quotation generator configured to provide product quotations; and
a user interface configured to receive user product specification input and dynamically create product specification queries based on received user product specification input.

14. The system of claim 13, wherein the server is further configured to host a user information database configured to store user identification information and user product specification input.

15. The system of claim 14, wherein the application software module is further configured to compare user identification information against a list of past user identification data stored in the user information database.

16. The system of claim 15, wherein the user interface is further configured to utilize past user product specification input to dynamically customize the product specification queries.
